(19) United States
(12) Patent Application Publication
(10) Pub. No.: US 2026/0278343 A1
(43) Pub. Date: Sep. 17, 2026

(54) APPARATUS AND METHOD FOR MEASURING LIKELIHOOD OF DATA THROUGH HIGH-DIMENSIONAL DISTRIBUTION ESTIMATION OF DATASETS

(71) Applicant: ELECTRONICS AND TELECOMMUNICATIONS RESEARCH INSTITUTE, Daejeon (KR)

(72) Inventors: Joong-won Hwang, Daejeon (KR); YU SEOK BAE, Daejeon (KR)

(21) Appl. No.: 19/352,626

(22) Filed: Oct. 8, 2025

(30) Foreign Application Priority Data
Mar. 12, 2025 (KR) 10-2025-0032150

(51) Int. Cl. G06N 3/047; G06N 3/0455; G06N 3/08

(52) U.S. Cl. CPC G06N 3/047; G06N 3/0455; G06N 3/08

(57) ABSTRACT

Disclosed is a measuring apparatus for measuring the likelihood of new input data related to a dataset including multi-dimensional data through high-dimensional distribution estimation of the dataset. The measuring apparatus includes an input module configured to receive input data, an AI module configured to transform high-dimensional data into low-dimensional data by using a feature embedding vector and to learn the joint probability of the high-dimensional data by combining a conditional probability corresponding to an associative relation between entities of the low-dimensional data for each dimension and a marginal probability that is generated based on the histogram of the low-dimensional data for each dimension, and an output module configured to output the likelihood of determining whether the new input data correspond to out-of-distribution data of the dataset based on the learnt joint probability.

### BACKGROUND

### 1. Technical Field

This specification relates to a kind of artificial intelligence technology and to a technology in which the out-of-distribution detection of learnt datasets for input data may be performed by learning a distribution of datasets. Through a method proposed in this specification, a user may determine the likelihood of subsequently input data by determining whether the subsequently input data belong to rare data or not in a corresponding dataset.

### 2. Related Art

To determine whether one datum is in-distribution data of a learning dataset or out-of-distribution data of the learning dataset is an important problem. One of the reasons is that it is necessary to assign the metacognitive ability to determine performance of the data to a machine learning model. Machine learning is performed based on the assumption that data obtained by not generalizing knowledge that is obtained through learning data can be analyzed. Accordingly, performance is not guaranteed with respect to an input other than a distribution in which knowledge is not generalized. For such a reason, a method of evaluating the reliability of the output value of a machine learning model by determining whether data are in-distribution data of a learning dataset is widely researched. In other words, in order to secure the reliability of artificial intelligence, there emerges a need for a technology for detecting out-of-distribution data.

In the past, a distribution of datasets may be inferred through a parametric modeling method or a non-parametric method. Such methods are excellent to describe a distribution of datasets to a human being, but have a limit in processing high-dimensional big data that are widely used in modern society.

### SUMMARY

Accordingly, this specification relates to an apparatus capable of statistically describing how unusual new data are based on the feature of a dataset, and provides a method of overcoming the curse of a dimension and being scalable while providing a description possibility, that is, an advantage of the existing non-parametric statistical data processing technology.

Furthermore, this specification provides a detailed method capable of measuring the likelihood of data and inferring whether data are out-of-distribution data with a learning goal to infer a high-dimensional distribution of data through a multi-layer neural network having excellent high-dimensional data processing ability.

A method proposed in this specification may be directly used in out-of-distribution detection, anomaly detection, and novelty discovery. Furthermore, the method may also be used in a process of improving performance of a main task of a multi-layer neural network, such as active learning, curriculum learning, or model selection in that the value of new data is determined compared to the existing dataset. Finally, the method may be used by being connected to a description possibility.

Technical objects to be achieved by the present disclosure are not limited to the aforementioned object, and the other objects not described above may be evidently understood from the following description by a person having ordinary knowledge in the art to which the present disclosure pertains.

In this specification, a measuring apparatus for measuring the likelihood of new input data related to a dataset including multi-dimensional data through high-dimensional distribution estimation of the dataset includes an input module configured to receive input data, an AI module configured to transform high-dimensional data into low-dimensional data by using a feature embedding vector and to learn the joint probability of the high-dimensional data by combining a conditional probability corresponding to an associative relation between entities of the low-dimensional data for each dimension and a marginal probability that is generated based on the histogram of the low-dimensional data for each dimension, and an output module configured to output the likelihood of determining whether the new input data correspond to out-of-distribution data of the dataset based on the learnt joint probability.

Furthermore, in this specification, the AI module includes a first multi-layer neural network configured to extract the feature embedding vector of the high-dimensional data, a tokenizer configured to transform the high-dimensional data into the permutation of the low-dimensional data by using the tokenization of an entity of the feature embedding vector for each dimension, memory configured to generate the histogram of the transformed low-dimensional data for each dimension and to store the marginal probability of the low-dimensional data, a second multi-layer neural network configured to learn the conditional probability and the joint probability by using a multi-layer neural network model, and a probability collection unit configured to calculate the joint probability by combining the conditional probability and the marginal probability according to a chain rule.

Furthermore, in this specification, the AI module obtains a set of the high-dimensional data as learning data, extracts the feature embedding vector including some dimensions of the high-dimensional data from the high-dimensional data, transforms the obtained high-dimensional data into the permutation of the low-dimensional data by performing encoding through the tokenization of the entity of the extracted feature embedding vector for each dimension, and learns a conditional probability corresponding to an associative relation between the entities of the transformed low-dimensional data for each dimension through the multi-layer neural network model.

Furthermore, in this specification, the second multi-layer neural network generates a plurality of encoding intervals for each entity by dividing an interval between a maximum value and minimum value of the entity of the extracted feature embedding vector for each dimension, searches for an encoding interval including an entity, among the plurality of encoding interval, sets a value of an entity corresponding to the retrieved encoding interval to “1” and sets a value of an entity corresponding to remaining intervals except the retrieved encoding interval to “0”, and performs encoding through the tokenization of the entity of the extracted feature embedding vector for each dimension.

Furthermore, in this specification, the multi-layer neural network model is a transformer using only a decoder.

Furthermore, in this specification, the conditional probability is a probability corresponding to a subsequent input value of the stream of previously input data.

Furthermore, in this specification, the first multi-layer neural network includes a feature extraction unit and a main task module.

Furthermore, in this specification, the encoded value is accumulated and stored in the memory for each dimension.

Furthermore, in this specification, a method of measuring the likelihood of new input data related to a dataset including multi-dimensional data through high-dimensional distribution estimation of the dataset includes receiving new input data, transforming high-dimensional data into low-dimensional data by using a feature embedding vector, learning the joint probability of the high-dimensional data by combining a conditional probability corresponding to an associative relation between entities of the low-dimensional data for each dimension and a marginal probability that is generated based on the histogram of the low-dimensional data for each dimension, and outputting the likelihood of determining whether the new input data correspond to out-of-distribution data of a dataset based on the learnt joint probability.

Furthermore, in this specification, the learning of the joint probability of the high-dimensional data includes extracting the feature embedding vector of the high-dimensional data, transforming the high-dimensional data into the permutation of the low-dimensional data by using the tokenization of an entity of the feature embedding vector for each dimension, generating the histogram of the transformed low-dimensional data for each dimension and storing the marginal probability of the low-dimensional data, learning the conditional probability and the joint probability by using a multi-layer neural network model, and calculating the joint probability by combining the conditional probability and the marginal probability according to a chain rule.

Furthermore, in this specification, the learning of the conditional probability and the joint probability by using the multi-layer neural network model further includes obtaining a set of the high-dimensional data as learning data.

Furthermore, in this specification, the feature embedding vector includes some dimensions of the high-dimensional data. The permutation of the low-dimensional data is transformed by being encoded through the tokenization of the entity of the feature embedding vector for each dimension.

Furthermore, in this specification, the encoding includes generating a plurality of encoding intervals for each entity by dividing an interval between a maximum value and minimum value of the entity of the extracted feature embedding vector for each dimension, searching for an encoding interval including an entity, among the plurality of encoding interval, and setting a value of an entity corresponding to the retrieved encoding interval to “1” and setting a value of an entity corresponding to remaining intervals except the retrieved encoding interval to “0”.

Furthermore, in this specification, an AI apparatus for learning a distribution of high-dimensional learning data sets includes a data transformation unit configured to extract a feature embedding vector of high-dimensional data and to perform a main task by using the extracted feature embedding vector, memory configured to generate the histogram of low-dimensional data for each dimension and to store the marginal probability of the low-dimensional data, a data learning unit configured to transform the high-dimensional data into the permutation of the low-dimensional data by using the tokenization of an entity of the extracted feature embedding vector for each dimension and to learn a conditional probability and a joint probability by using a multi-layer neural network model, and a probability collection unit configured to calculate the joint probability by combining the conditional probability and the marginal probability according to a chain rule.

This specification may provide the following effects.

First, the high-dimensional big data learning capability of a multi-layer neural network may be used.

The existing statistical technique has a limit to the ability to process high-dimensional big data. As the dimension of a histogram is increased, a required storage capacity is exponentially increased, and it is difficult to find a meaningful distribution even in a distribution of data. A kernel density estimation method has the ability to process high-dimensional data, but has a problem the complexity of an inference operation is increased in proportion to an increase in the number of data that constitute a dataset.

A multi-layer neural network well processes high-dimensional data and is excellent in memorizing learning data itself. Accordingly, the method proposed in this specification enables a distribution of high-dimensional data to be estimated by using a multi-layer neural network in a task of learning a distribution relation between the dimensions of extracted feature embeddings, in addition to simply extracting feature embedding by actively using the ability to process high-dimensional information of such a multi-layer neural network. Such a method has a characteristic in which although the number of data is increased, the complexity of an inference operation is not increased and learning performance becomes better.

Second, it is possible to directly provide the likelihood numerical value of data.

The existing multi-layer neural network-based methods estimate a relation between a learning dataset and a dataset through an indirect method and a numerical value. For example, the existing multi-layer neural network-based methods determine whether data are out-of-distribution data by measuring the flatness of result values with marginal data, measuring a distance from a prototype, or measuring a degree of restoration of a generated image. A numerical value that is used in such a method does not present an explanation for how low the possibility would have been derived from the existing distribution.

In contrast, the method proposed in this specification enables a multi-layer neural network to directly estimate how much are data rare in a distribution learning of data by allowing the multi-layer neural network to directly learn a data distribution of a learning dataset. The method presents a high description possibility compared to the existing method because the likelihood of data is directly estimated.

Third, it is easy to implement the method as a learning structure having an add-on form.

Today, the artificial intelligence field follows a trend to actively use a foundation model. The foundation model is used for feature embedding. If the foundation model is fine-tuned by a specific main task, it was experimentally found that good characteristics, such as a zero-shot characteristic and a continued learning ability are heavily sacrificed.

Out-of-distribution data detection technologies of the existing multi-layer neural network are greatly influenced by performance of feature embedding. In researches that belong to such a method, to maintain performance of a main task when a multi-layer neural network is trained again in order to detect out-of-distribution data is an important benchmarking numerical value. The reason for this is that corresponding methods are based on the assumption that the feature embeddings of a learning dataset will be gathered in a specific form in an embedding space and that it is valid to train the feature extraction unit of the multi-layer neural network based on such assumption.

The method proposed in this specification does not assume that the data of a learning dataset will be gathered in a specific form in an embedding space. The method may be applied to any form of a feature extraction unit because an arbitrary feature embedding space is segmented based on the number of bins of a histogram and a method of learning a distribution of each section is used. Accordingly, the method has advantages in that the method can be easily implemented on the existing model that performs a main task in an add-on form and easily uses the foundation model.

Effects of the present disclosure which may be obtained in the present disclosure are not limited to the aforementioned effects, and the other effects not described above may be evidently understood by a person having ordinary knowledge in the art to which the present disclosure pertains from the following description.

### BRIEF DESCRIPTION OF THE DRAWINGS

The accompanying drawings, which are included as part of the detailed description in order to help understanding of the present disclosure, provide embodiments of the present disclosure and describe the technical characteristics of the present disclosure along with the detailed description.

FIG. 1 illustrates an example of an internal block diagram of an apparatus to which a method proposed in this specification may be applied.

FIG. 2 illustrates an example of an internal block diagram of an AI module to which the method proposed in this specification may be applied.

FIG. 3 illustrates another example of an internal block diagram of an apparatus for measuring the likelihood of new input data through high-dimensional distribution inference, which is proposed in this specification.

FIG. 4 is a flowchart illustrating an example of a process of learning a distribution of high-dimensional learning datasets, which is proposed in this specification.

FIG. 5 is a flowchart illustrating an example of a process of inferring the likelihood of new inference data based on a distribution of learnt learning datasets, which is proposed in this specification.

FIG. 6 is a diagram illustrating an example in which a feature embedding vector is tokenized for each dimension and changed into a sequential input, which is proposed in this specification.

FIG. 7 illustrates an example of a method of histogramming the dimension of feature embedding, which is proposed in this specification.

FIG. 8 is a diagram illustrating an example of a method of learning and processing, by a multi-layer neural network, a sequential input, which is proposed in this specification.

FIG. 9 is a diagram illustrating an example of a usage method of connecting the method proposed in this specification to an external multi-layer neural network.

FIG. 10 is a flowchart illustrating an example of a method of measuring the likelihood of input data through high-dimensional distribution estimation, which is proposed in this specification.

### DETAILED DESCRIPTION

It is to be noted that technological terms used in this specification are used to describe only specific embodiments and are not intended to limit this specification. Furthermore, the technological terms used in this specification should be construed as having meanings that are commonly understood by those skilled in the art to which this specification pertains unless especially defined as different meanings otherwise in this specification, and should not be construed as having excessively comprehensive meanings or excessively reduced meanings. Furthermore, if the technological term used in this specification is a wrong technological term that does not precisely represent the spirit of a technology disclosed in this specification, the technological term should be replaced with a technological term which may be correctly understood by a person having ordinary knowledge in the field disclosed in this specification and understood. Furthermore, common terms used in this specification should be interpreted in accordance with the definition of dictionaries or in accordance with the context, and should not be construed as having excessively reduced meanings.

Furthermore, terms including ordinal numbers, such as a “first” and a “second”, which are used in this specification, may be used to describe various components, but the components are not restricted by the terms. The terms are used to only distinguish one component from the other components. For example, a first component may be named a second component without departing from the scope of rights of this specification. Likewise, the second component may be named the first component.

Hereinafter, embodiments according to this specification are described in detail with reference to the accompanying drawings. The same or similar component is assigned the same reference numeral regardless of its reference numeral, and a redundant description thereof is omitted.

Furthermore, in describing this specification, a detailed description of a related known technology will be omitted if it is deemed to make the subject matter of this specification unnecessarily vague. Furthermore, the accompanying drawings are merely intended to make easily understood the spirit of this specification, and the spirit of this specification should not be construed as being restricted by the accompanying drawings.

Prior to a description of a method proposed in this specification, the existing methods are described in brief.

First, one of the existing methods is a parametric model technology combined with a meta feature technology. There was research of a meta feature technology in which a dataset is expressed in simple numbers. In the meta feature technology, after the data of a dataset are embedded in a specific space, a distribution of the datasets is indicated as statistical parameters, such as entropy, the mean, a variance, skewness, and Kurtosis. Thereafter, a probability that data will be derived in a corresponding distribution model is estimated by putting a corresponding meta feature numerical value into a parametric model and measuring the likelihood of input data. Such a method is easy and simple, but assumption for a distribution model of datasets is required and has performance decline attributable to model misspecification when there is a difference in the actual distribution with respect to the assumed model. Furthermore, the parametric model has a problem in that it does not contain a complicated distribution because the parametric model has a mathematically concise form.

Second, one of the existing methods is a non-parametric statistical data processing technology. Statistical data processing schemes, such as histogram or kernel density estimation, play a role of collecting data samples so that data can estimate a form of a sampled base probability distribution. The statistical data processing scheme may be used in a classification problem through the likelihood of how likely or not corresponding data are to come out when a new data sample is input based on the base probability distribution estimated as described above. Such a statistical scheme has advantages in that a global distribution can be checked and the statistical scheme is non-parametric because specific assumption is not required in a distribution. The statistical scheme has a small performance decline attributable to model misspecification and can also express a complicated distribution because the statistical scheme is non-parametric.

However, such an existing statistical data processing scheme has problems in that it is difficult to process high-dimensional data due to the curse of a dimension (in the case of a histogram) and the existing statistical data processing scheme is not scalable to the number of data (in the case of kernel density estimation). The existing statistical data processing scheme has a limit in solving such a problem because data that area used in recent machine learning are commonly high-dimensional big data.

In order to determine out-of-distribution data of a multi-layer neural network of the most common machine learning technology of a modern era, the following technologies of three paradigms are basically developed.

Such technologies give some help in sorting out out-of-distribution data.

However, most of the technologies each include a heuristic part, and feature embedding needs to be processed to be suitable for sorting out out-of-distribution data. Accordingly, the technologies have disadvantages in that performance of a main task is reduced and a description possibility is insufficient.

Third, one of the existing methods is a confidence score-based method. In the confidence score-based method, a network determines whether input data are the in-distribution data or out-of-distribution data of learning data based on the confidence score of a main task of a multi-layer neural network. The confidence score-based method includes clearly distinguishing between data learnt by the multi-layer neural network and the in-distribution data and starts from the assumption that data other than the data learnt by the multi-layer neural network and the in-distribution data will be unclearly sorted out.

However, in general, this is not the fact. The multi-layer neural network model frequently overtrusts its determination. Due to the overtrust, many researches revealed that a high score is also assigned to out-of-distribution data. In order to improve such a problem, a method of improving feature embedding is attempted. This requires the re-training of a multi-layer neural network. Although the reliability of the multi-layer neural network is improved through the re-training, performance of a main task is often reduced.

As part of such a paradigm, a method of monitoring marginal data of input data and monitoring the confidence score of the marginal data is also attempted. Such a method is not scalable when learning data are increased and has a low description possibility of how much the classification score of marginal data is related to reliability because the method requires memory that stores marginal data and a process of indexing such memory.

Fourth, one of the existing methods is a prototype network technology. The prototype-based network discovers the prototype of representative data included in a specific dataset and helps to determine how similar new data are to their prototype.

Universally, the prototype-based network determines how similar new data are to their prototype by picking out feature embedding from a trained network, picking out the center value of data belonging to a dataset, using the center value as a prototype, and then calculating a distance between the new data and the prototype.

A prototype-based network and such a paradigm are suitable for a high-dimensional data distribution because they can actively use the high-dimensional analysis ability of a multi-layer neural network. The prototype-based network and the paradigm are used in out-of-distribution detection, anomaly detection, and novelty discovery and are also widely used when the summary of a dataset, such as continual learning or few-shot learning, is required.

However, the prototype-based network requires heuristic assumption for a base distribution in setting a prototype and greatly depends on the heuristic assumption. To use the center value as the prototype and compare similarities through a distance metric is based on the assumption that the data of a specific group have a symmetrical distribution (i.e., single modality) having one center value. However, if feature embedding learnt for a main task has single modality, this is a very special situation. A reduction in reliability estimation performance attributable to model misspecification like a parametric scheme is often experienced.

Fifth, one of the existing methods is a reconstruction technology using a generative pair model. In general, the reconstruction method using the generative pair model includes a process of training two multi-layer neural networks. One of the two multi-layer neural networks is an encoder multi-layer neural network that warps input data into an embedding space. The other of the two multi-layer neural networks is a decoder multi-layer neural network that makes a feature embedded as described above in a form, such as input data, again. In this method, the multi-layer neural network is trained as an object function in which the input of the encoder and the output of the decoder are perfectly the same. If such a structure performs the reconstruction of learning data almost completely, it may be expected that new data from a base distribution, such as learning data, will also be well reconstructed. However, data from a distribution different from a distribution of learning data will not be properly reconstructed. Whether data have been derived from the same base distribution as learning data may be determined because a reconstruction loss can be determined even without human intervention.

However, such a method is greatly influenced by the characteristic and performance of an embedding space. Furthermore, such a method is to indirectly measure the characteristic of data, and has a limit in that it is difficult to expand and interpret the numerical value of a reconstruction loss to the degree of heterogeneity of data. This is due to the lack of evidence that the numerical value of the reconstruction loss is proportional to a distance within the embedding space. As a result, the method operates as limited functionality with respect to a description possibility for an operation of a multi-layer neural network.

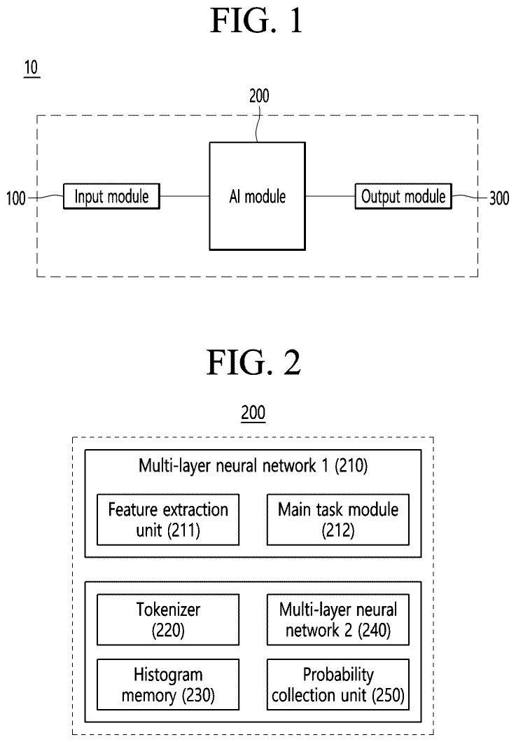

FIG. 1 illustrates an example of an internal block diagram of an apparatus to which a method proposed in this specification may be applied.

A measuring apparatus 10 that is used in this specification is a device for measuring the dataset-related likelihood of new input data through the method proposed in this specification, that is, through the high-dimensional distribution estimation of a dataset including multi-dimensional data. The measuring apparatus 10 may include a portable terminal, a smartphone, a laptop computer, a navigator, a tablet PC, a wearable device, a drone, a camera, a blackbox, and CCTV, and may be called a measuring device, a data processing apparatus, or a processing apparatus.

Furthermore, components illustrated in FIG. 1 are not essential in implementing the measuring apparatus 10. The measuring apparatus described in this specification may have more or less components than the components listed above.

Referring to FIG. 1, the measuring apparatus 10 may include an input module 100, an AI module 200, and an output module 300 in order to implement the method proposed in this specification.

The input module 100 is a mode that receives input data, and may be called a data input module or a data input unit.

The AI module 200 refers to a module that transforms high-dimensional data into low-dimensional data by using a feature embedding vector and that learns the joint probability of the high-dimensional data by combining a conditional probability corresponding to an associative relation between the entities of the low-dimensional data for each dimension and a marginal probability that is generated based on the histogram of the low-dimensional data for each dimension.

The output module 300 refers to a module that outputs the likelihood of new input data that determines whether the new input data are included in a distribution of a dataset based on a joint probability that is learnt by the AI module.

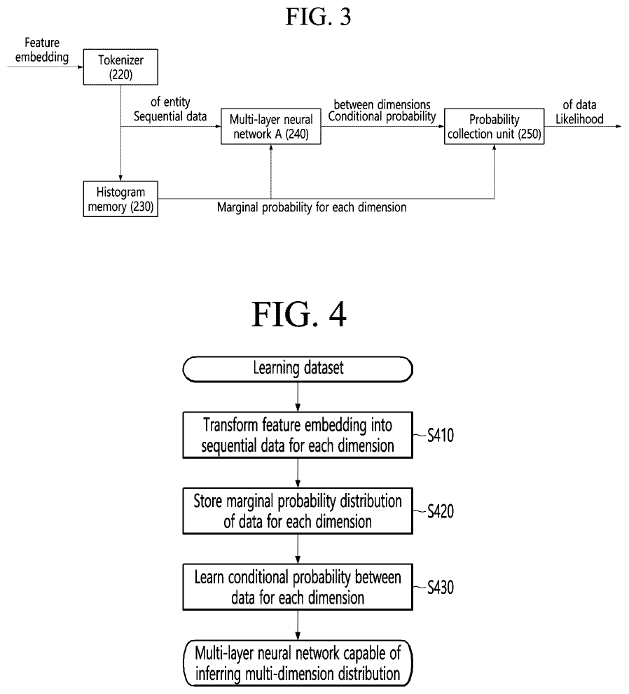

FIG. 2 illustrates an example of an internal block diagram of an AI module to which the method proposed in this specification may be applied. FIG. 3 illustrates another example of an internal block diagram of an apparatus for measuring the likelihood of new input data through high-dimensional distribution inference, which is proposed in this specification.

The AI module 200 may be included in at least some components of the measuring apparatus 10 (hereinafter referred to as the “apparatus” for convenience's sake) illustrated in FIG. 1, and may be provided to perform at least some of AI processing together.

The AI module 200 relates to a module capable of training a neural network, and may be called an AI apparatus, an AI processor, or an AI chip.

Referring to FIG. 2, the AI module 200 may include a multi-layer neural network 1 210, a tokenizer 220, memory 230, a multi-layer neural network 2 240, and a probability collection unit 250.

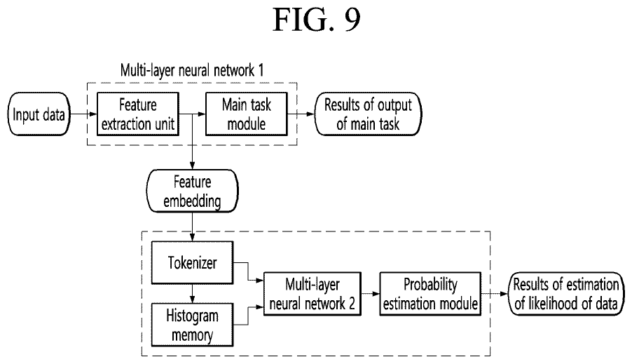

The multi-layer neural network 1 210 may be a neural network that processes an image, text, and audio according to a user's purpose, and may include a feature extraction unit 211 that warps a high-dimensional input into feature embedding, that is, a relatively low dimension, and a main task module 212 that performs a main task through the feature embedding. The multi-layer neural network 1 is described more specifically with reference to FIG. 9.

The multi-layer neural network 1 including the feature extraction unit and the main task module may be called a data transformation unit.

That is, the data transformation unit may extract the feature embedding vector of high-dimensional data and perform a main task by using the extracted feature embedding vector.

Components of the AI module that are required to implement a method of inferring the likelihood of new inference data based on a distribution of learning datasets, which is proposed in this specification, may include the tokenizer, the multi-layer neural network 2, the memory, and the probability collection unit. Hereinafter, the tokenizer, the multi-layer neural network 2, the memory, the probability collection unit, and a flow of data between corresponding components are described more specifically with reference to FIGS. 2 and 3.

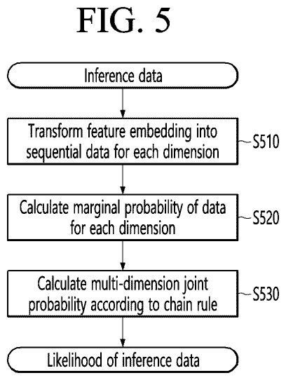

The tokenizer 220 transforms feature embedding into sequential data for each dimension, that is, performs step S410 in FIG. 4 and step S510 in FIG. 5.

The memory 230 generates the histogram of the transformed low-dimensional data for each dimension and stores the marginal probability of the low-dimensional data, that is, performs step S420 in FIG. 4. The memory that stores the histogram may be called histogram memory.

The memory 230 may store various programs and data that are necessary for an operation of the AI module. The memory may be implemented with non-volatile memory, volatile memory, flash memory, a hard disk drive (HDD), or a solid state drive (SDD). The memory is accessed by the AI module (or the AI processor). The reading/writing/modification/deletion/update of data by the AI module may be performed on the memory. Furthermore, the memory may store a neural network model (e.g., a multi-layer neural network model) that is generated through a learning algorithm according to an embodiment of the present disclosure.

The multi-layer neural network 2 240 learns a conditional probability distribution between data for each dimension and calculates the conditional probability of data for each dimension, that is, performs step S430 in FIG. 4 and step S520 in FIG. 5.

The probability collection unit 304 calculates a multi-dimensional joint probability according to a chain rule, that is, performs step S530 in FIG. 5.

In step S410 of FIG. 4 (i.e., transforms feature embedding into sequential data for each dimension), which is performed by the tokenizer 220, a method of making the entity of a vector for each dimension the permutation of one-dimensional data by representatively using the entity of the vector for each dimension as low-dimensional data. This method is the most intuitive method and is described based on the most intuitive method. However, the present disclosure proposed in this specification is not limited to the method, and a method of grouping several dimensions to the best of the direct estimation and storage of a marginal probability may also be used.

Furthermore, in the process of performing, by the AI module, step S410 in FIG. 4 and step S510 in FIG. 5, the tokenizer may help the learning of the multi-layer neural network 2 by warping the low-dimensional data in a form in which the multi-layer neural network 2 better learns the low-dimensional data. Data that are generated through such a warping process correspond to encoded data.

Furthermore, the memory 230 may help a learning process and inference process of the multi-layer neural network 2. The memory stores information on the marginal probability of at least one type of low-dimensional data. This process is used to calculate the joint probability according to the chain rule in the inference step. Furthermore, histogram memory may be used in order to obtain a regularization effect in the learning process of one type or several types of memory. In this case, the term “histogram memory” is merely used to correspond to the “prototypical memory,” which stores representative values of data rather than distributions. The term does not necessarily require the use of a histogram structure. Any other form of storage that is configured to record a distribution of a dataset in a scalable manner with respect to the number of data points, including but not limited to histogram-based structures, also falls within the scope of the present invention.

Furthermore, the multi-layer neural network 2 240 refers to a multi-layer neural network having a structure in which sequential data can be processed like a transformer. The multi-layer neural network 2 performs a function for predicting the rear part of sequential data through the front part of the sequential data. That is, the method proposed in this specification is related to performing a task for outputting a conditional distribution of the rear part entities of a high-dimensional data vector by using a distribution of the front part entities of the high-dimensional data vector as an input.

Furthermore, the probability collection unit 250 corresponds to a calculation module that calculates a final joint probability by synthesizing a marginal probability and a conditional probability according to the chain rule.

The tokenizer 220 and the multi-layer neural network 2 240 may be represented as a data learning unit. The data learning unit learns the conditional probability and the joint probability by using a multi-layer neural network model.

More specifically, the data learning unit includes a model learning unit, may transform the high-dimensional data into the permutation of the low-dimensional data by performing encoding through the tokenization of the entity of the extracted feature embedding vector for each dimension, and may learn a conditional probability corresponding to an associative relation between the entities of the transformed low-dimensional data for each dimension through the multi-layer neural network model.

In this case, if the tokenizer and the multi-layer neural network 2 are implemented as the data learning unit, the data learning unit may be manufactured in the form of at least one hardware chip and mounted on the AI module. For example, the data learning unit may be manufactured in the form of a dedicated hardware chip for artificial intelligence (AI), and may be manufactured as a part of a general-purpose processor (CPU) or a graphic dedicated processor (GPU) and mounted on the AI module. Furthermore, the data learning unit may be implemented as a software module. If the data learning unit is implemented as a software module (or a program module including instructions), the software module may be stored in non-transitory computer-readable media. In this case, at least one software module may be provided by an operating system (OS) or may be provided by an application.

FIG. 4 is a flowchart illustrating an example of a process of learning a distribution of high-dimensional learning datasets, which is proposed in this specification.

In the present disclosure proposed in this specification, a set of high-dimensional data which may be expressed as a vector is used as learning data.

First, the apparatus transforms a high-dimensional vector into the permutation of low-dimensional data including only some dimensions (S410).

Furthermore, the apparatus stores a marginal probability distribution of the low-dimensional data (S420). In this case, as an example of an implementation of a method of storing the marginal probability distribution, a histogram may be used. In addition to the histogram, another similar storage method may be used.

Furthermore, the apparatus learns a conditional probability, that is, an associative relation between the plurality of data for each dimension, which is generated in step S410 (S430).

FIG. 5 is a flowchart illustrating an example of a process of inferring the likelihood of new inference data based on a distribution of learnt learning datasets, which is proposed in this specification.

First, the apparatus transforms the entities of data to be inferred for each dimension into sequential data for each dimension like learning data (S510).

Furthermore, the system calculates the conditional probability of the data for each dimension according to the conditional probability distribution for each dimension, which has been learnt in step S430 in FIG. 4 (S520).

Furthermore, the apparatus calculates the joint probability of the inference data as likelihood by merging the calculated conditional probability of the data for each dimension according to the chain rule (S530).

As described above, the apparatus proposed in this specification finds out the likelihood of input data in order to determine out-of-distribution data of a learning dataset in the inference step.

To this end, the multi-layer neural network 2 within the apparatus is required to be trained so that the multi-layer neural network 2 can infer the joint probability of the embedded high-dimensional feature vector of high-dimensional input data or input data. Such a training method is described below more specifically.

The joint probability distribution of the high-dimensional data cannot be directly stored. Accordingly, it is also impossible to directly infer the likelihood of the high-dimensional data from the stored distribution. Accordingly, in the present disclosure proposed in this specification, the high-dimensional data are transformed into the permutation of the low-dimensional data. After the marginal probability distribution of the data transformed in the low dimension is stored in the histogram memory, the multi-layer neural network is trained to infer a conditional probability between permutation elements. Furthermore, the apparatus calculates the joint probability by combining the marginal probability distribution and the conditional probability in the inference step.

It is assumed that data to be processed by the apparatus to which the method proposed in this specification may be applied or the feature embedding of the corresponding data is an N dimension vector. A corresponding vector is expressed as x={x₁, x₂, . . . , x_{N}}∈ [symbol] ^{N} by way of notation, and is named a “feature embedding vector”, for convenience's sake. The multi-layer neural network 2 learns and infers a joint probability by considering x₁, x₂, . . . , x_{N}, that is, the entities of x, as N sequential inputs by using x₁, x₂, . . . , x_{N} as respective inputs. The multi-layer neural network 2 learns the joint probability as learning data, and infers the joint probability by applying the joint probability to the input data in the inference step.

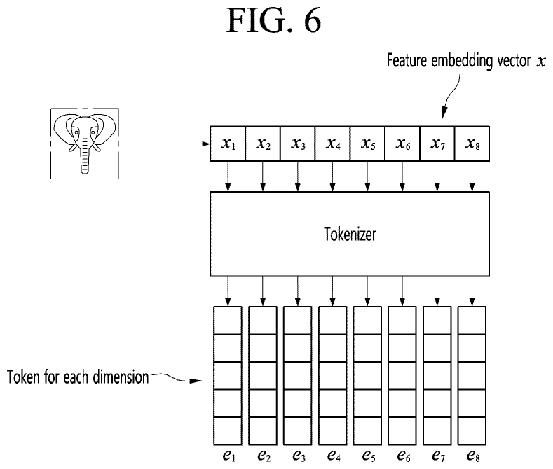

FIG. 6 is a diagram illustrating an example in which a feature embedding vector is tokenized for each dimension and changed into a sequential input, which is proposed in this specification.

That is, FIG. 6 illustrates an embodiment in which the entity of feature embedding of one datum is tokenized for each dimension and transformed into a sequential input. The entities x₁, x₂, . . . , x_{N} of the input data vector x are encoded in the tokenizer by being treated as individual input data. In FIG. 6, the encoding in the tokenizer illustrates an embodiment in which one-hot encoding is performed. The feature embedding x of all data included in learning data may be picked out. In this case, after an interval is produced by dividing a value between a maximum value and minimum value of each entity, one-hot encoding is performed based on a corresponding interval. For example, assuming that a maximum value of x₁ of data within a learning dataset is max(x₁) and a minimum value of x₁ of the data within the learning data is min (x₁), if a value between the maximum value and the minimum value is divided into M, the value of the first entity x′ of the feature embedding vector x′₁ a of specific data is included in a k-th interval that satisfies

$$min ( {x}_{1} ) + ( k - 1 ) \frac{max ( {x}_{1} ) - min ( {x}_{1} )}{M} < {x}_{1}^{′} < min ( {x}_{1} ) + k \frac{max ( {x}_{1} ) - min ( {x}_{1} )}{M} .$$

In such a case, x′₁ is encoded into an M dimension vector e₁ having a form in which only a t-th entity is 1 and the remaining entities are 0. The entities x′₂, x′₃ . . . x′_{N} of another dimension are also encoded into e₂, e₃ . . . e_{N}, respectively. Such an encoding method is not limited to the one-hot encoding exemplified in FIG. 6, and may have several embodiments which may have similar effects. In FIG. 6, N=8, M=5.

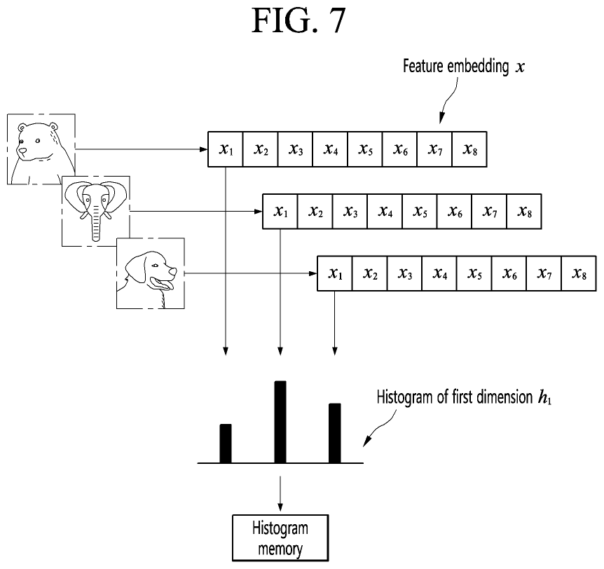

FIG. 7 illustrates an example of a method of histogramming the dimension of feature embedding, which is proposed in this specification.

That is, FIG. 7 illustrates an embodiment in which the first dimension of feature embedding extracted from a plurality of image data within a learning dataset is histogrammed and then stored in the histogram memory.

The encoded values of the data within the learning dataset are accumulated for each dimension, histogrammed and stored in the histogram memory. Practically, feature values are collected and stored in the histogram memory with respect to all of other dimensions in addition to the first dimension. Through such a process, the marginal probability p(x₁), p(x₂), . . . , p(xₙ) of each dimension of the learning dataset may be stored.

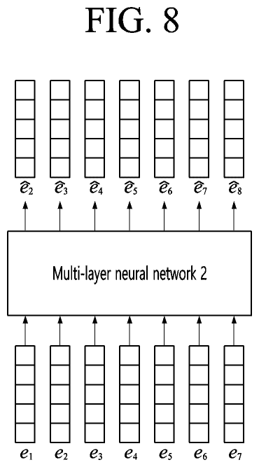

FIG. 8 is a diagram illustrating an example of a method of learning and processing, by a multi-layer neural network, a sequential input, which is proposed in this specification.

The multi-layer neural network 2 is a neural network capable of processing sequential inputs, and plays a role of predicting an encoded input stream e₁, e₂ . . . e_{N}. The structure of a neural network which may be used as the multi-layer neural network 1 representatively includes a decoder-only transformer in which only a decoder part is used, and may also include another model in which a transformer is partially improved. The multi-layer neural network is trained to output a prediction value êₙ for eₙ, that is, a next input value, through a previous input stream e₁, e₂ . . . e₍ₙ₋₁₎. This process is the same as a process of predicting and generating a subsequent word token through previous word tokens in a transformer-based sentence generation model. One-hot encoding expresses which interval (bin) an input value belongs to within the histogram as an event probability and encoding and decoding are evidently possible. Accordingly, through such a process, the multi-layer neural network 2 learns the conditional probability p(xₙ|x₁, x₂ . . . x₍ₙ₋₁₎) of a subsequent input xₙ to a previous input stream x₁, x₂ . . . x₍ₙ₋₁₎.

Furthermore, information which may be used as a loss for training the multi-layer neural network 2 basically includes two types. The first is a base truth function for the input stream e₁, e₂ . . . eₙ. The base truth function is learnt in a self-supervised learning form. Kullback-Leibler divergence between eₙ and êₙ may be used in the base truth function. The base truth function is expressed as a loss function [symbol] ₁ (eₙ, êₙ). The second is a marginal probability distribution for each dimension. A conditional probability distribution may be normalized with the assumption that the conditional probability distribution will be somewhat similar to a marginal probability distribution. The marginal probability distribution may be expressed as [symbol] ₂ (eₙ, hₙ). A Kullback-Leibler distance or another similar function may be used in the marginal probability distribution. A final loss function is obtained as in Equation 1 by introducing a constant that adjusts a weight between the two loss functions.

$$ℒ = {ℒ}_{1} ( {e}_{n} , {\hat{e}}_{n} ) + {αℒ}_{2} ( {e}_{n} , {\hat{h}}_{n} ) \qquad ( 1 )$$

In the inference step, the conditional probability distribution that is calculated through êₙ inferred with respect to input data is output. Accordingly, the likelihood of data is calculated. êₙ denotes p(xₙ|x₁, x₂ . . . x₍ₙ₋₁₎). Accordingly, the conditional likelihood of

$$p ( {x}_{n} = {x}_{n}^{′} \vert {x}_{1} = {x}_{1}^{′} , {x}_{2} = {x}_{2}^{′} … {x}_{( n - 1 )} = {x}_{n}^{′} )$$

may be calculated through p(xₙ|x₁, x₂ . . . x₍ₙ₋₁₎). A joint probability may be calculated by multiplying the conditional likelihood by the conditional likelihood that was previously calculated according to the chain rule. Finally, the likelihood of the data may be calculated. In the rightmost term in Equation 2, p(x₁) is directly calculated in the histogram for each dimension, and the remainder is calculated by using the inferred êₙ as a histogram.

$$p ( x ) = p ( {x}_{1} , {x}_{2} … {x}_{N} ) = p ( {x}_{1} ) p ( {x}_{2} \vert {x}_{1} ) … p ( {x}_{n} \vert {x}_{( n - 1 )} , {x}_{( n - 2} ) … {x}_{1} ) \qquad ( 2 )$$

According to an implementation method, the histogram may be used in the inference step.

The implementation method is a method of enabling the multi-layer neural network 2 to output: êₙ/hₙ instead of êₙ and calculating the conditional likelihood by multiplying the output of the multi-layer neural network 2 and the histogram for each dimension in an inference situation. In this case, there is an effect in that the results of the histogram are more based than the results of the multi-layer neural network 2 because more normalization is performed in the inference step.

The data likelihood measurement method through high-dimensional distribution inference that is proposed in this specification is different from the existing statistical scheme as follows.

When compared with a parametric method combined with a meta feature, the present disclosure proposed in this specification does not assume that the dataset will follow a specific probability model because the non-parametric method is used in the present disclosure. The multi-layer neural network may approximate an arbitrary multivariate function according to universal approximate theorem. Accordingly, if learning is properly performed, the present disclosure is not influenced by performance decline attributable to model misspecification.

Furthermore, when compared with the existing non-parametric statistical data processing technology, the present disclosure proposed in this specification has a characteristic suitable for modern data. Specifically, kernel density estimation has a disadvantage in that as data are increased, a computational load is increased because a distribution is calculated by adding distances between data points. When compared with the kernel density estimation, the present disclosure proposed in this specification does not have the disadvantage in that a computational load is increased because a histogram collected from distributions or a form similar to the histogram is stored.

Furthermore, in the existing histogram method, it is impossible to directly store a high-dimensional histogram. In contrast, the present disclosure proposed in this specification enables high-dimensional distribution estimation because a method of training the multi-layer neural network that merges low dimension histograms after storing the low dimension histograms instead of directly storing high-dimensional histograms is used.

For a comparison with the out-of-distribution data estimation technologies of the multi-layer neural network, a usage method of the present disclosure proposed in this specification, which can perform the method of training the multi-layer neural network, is described and then compared with the out-of-distribution data estimation technologies.

FIG. 9 is a diagram illustrating an example of a usage method of connecting the method proposed in this specification to an external multi-layer neural network.

That is, FIG. 9 relates to a method of determining whether input data to a multi-layer neural network B, that is, an external multi-layer neural network that operates independently of the present disclosure proposed in this specification, are out-of-distribution data by connecting a high-dimensional data distribution inference technology proposed in this specification to the multi-layer neural network B.

The multi-layer neural network B may be a multi-layer neural network that processes an image, text, and audio according to a user's purpose. Such a processing process is called a main task. The multi-layer neural network B may be basically divided into two, which includes a feature extraction unit that warps a high-dimensional input as feature embedding, that is, a relatively low dimension, and a main task module that performs a main task based on the feature embedding generated as described above. Such a division includes both a case in which the multi-layer neural network is arbitrarily divided according to an abstract concept and a case in which the multi-layer neural network may be substantially divided. The case in which the multi-layer neural network is arbitrarily divided according to an abstract concept includes a case in which the multi-layer neural network is divided on the basis of a corresponding layer assuming that the intermediate result information of the second last layer (i.e., a penultimate layer) has been most compressed as a low dimension. The case in which the multi-layer neural network may be substantially divided includes a case in which a fine-tuned main task module is connected to a foundation model.

In FIG. 9, the multi-layer neural network 2 learns a distribution of learning datasets of the multi-layer neural network B so that the multi-layer neural network 2 can determine whether an input to the multi-layer neural network 1 is out-of-distribution data. In this case, a feature embedding vector, that is, the intermediate output of the multi-layer neural network B, is connected in a way that a system receives the feature embedding vector as an input so that a feature embedding space can be shared with the multi-layer neural network B. Thereafter, in the inference step, the multi-layer neural network 2 learns a distribution based on learning datasets of the multi-layer neural network 1, and infers the likelihood of how likely data input in the inference stage are in its distribution. If the likelihood of the input data is not sufficiently high, the input data are data having a form, which are not included in a learnt dataset in the learning process of the multi-layer neural network 1. The multi-layer neural network 2 determines that the results of the task of the multi-layer neural network 1 for the input data are not sufficiently reliable.

Through such a method, a method of estimating out-of-distribution data of the multi-layer neural network B has the following differences.

### (1) Confidence Score-Based Method

In the confidence score-based method, whether input data are out-of-distribution data is determined based on an output value, that is, a result of the processing a main task. It was experimentally found that it is difficult to determine out-of-distribution data based on only the output value of a common multi-layer neural network trained for the main task. Accordingly, various supplementation methods, such as improving the out-of-distribution data classification ability by changing and learning a loss function that is used in the learning process or comparing the output of data other than the input data with the input data. However, all of such methods have something in common in that the methods are performed based on the input and output relation of the main task.

The method proposed in the present disclosure is different in that the method uses a multi-layer neural network that plays a role different from the main task. The multi-layer neural network 2 shares feature embedding with the multi-layer neural network B that performs the main task, but is different in that the multi-layer neural network 2 learns a distribution relation between the dimensions of feature embedding rather than directly learning corresponding feature embedding.

### (2) Prototype-Based Network

The prototype-based network and the present disclosure proposed in this specification have something in common in that information on a learning dataset is stored in memory and the specificity of data input in the inference step is used when the data are determined. The prototype-based network performs the same role as the multi-layer neural network B of the present disclosure, and may form the prototype of learning data and store the prototype in the memory.

Both the prototype-based network method and the present disclosure store the contents of learning data in the memory, but have great differences in stored contents and a usage method in the inference step. The prototype-based network determines the specificity of input data by simply calculating a distance between the embedding value of the input data and the embedding value of prototype data. In contrast, in an embodiment of the present disclosure, a histogram for each dimension not a prototype is stored in the memory. Furthermore, the likelihood of input data is calculated by introducing the multi-layer neural network 2 that has learnt a probability distribution of high-dimensional embedding features.

### (3) Reconstruction Method Using Generative Pair Model

The reconstruction method using the generative pair model and the present disclosure have something in common in that an input is restored through an embedded feature in a semi-supervised learning way. In the learning process, a reconstruction loss of the generative pair model is learnt in a way similar to [symbol] ₁ (eₙ, êₙ) in the present disclosure.

The learning methods have such similarity, but the object of learning and usage methods are greatly different between the generative pair method and the present disclosure. The generative pair method depends on an indirect index called restoration performance in order to determine whether data input in the inference step have been derived from a distribution similar to that of learning data. The generative pair model monitors whether input data have been properly restored, and determines that the input data have been derived from a distribution similar to that of learning data not data other than the distribution if the input data have been well restored. In contrast, in an embodiment of the present disclosure, the multi-layer neural network directly learns a conditional likelihood, and calculates a joint likelihood by combining the conditional likelihood according to the chain rule in the inference step.

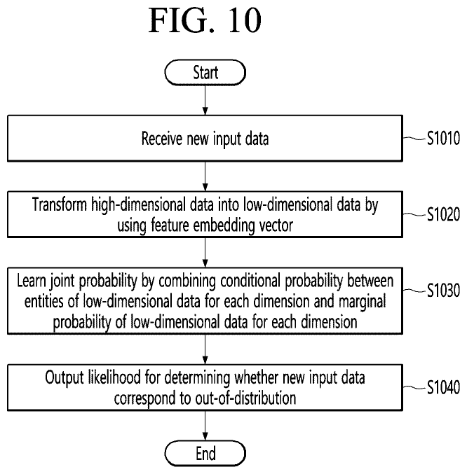

FIG. 10 is a flowchart illustrating an example of a method of measuring the likelihood of input data through high-dimensional distribution estimation, which is proposed in this specification.

First, the apparatus receives new input data (S1010).

Furthermore, the apparatus transforms high-dimensional data into low-dimensional data by using a feature embedding vector (S1020).

Furthermore, the apparatus learns the joint probability of the high-dimensional data by combining a conditional probability corresponding to an associative relation between the entities of the low-dimensional data for each dimension and a marginal probability that is generated based on the histogram of the low-dimensional data for each dimension (S1030).

Furthermore, the apparatus outputs the likelihood of determining whether the new input data are included in a distribution of datasets based on the learnt joint probability (S1040).

The learning of the joint probability of the high-dimensional data in step S1030 may be materialized through a process of extracting the feature embedding vector of the high-dimensional data, transforming the high-dimensional data into the permutation of the low-dimensional data by using the tokenization of the entity of the feature embedding vector for each dimension, generating the histogram of the transformed low-dimensional data for each dimension, storing the marginal probability of the low-dimensional data, learning the conditional probability and the joint probability by using the multi-layer neural network model, and calculating the joint probability of the conditional probability and the marginal probability according to the chain rule.

Furthermore, the feature embedding vector includes some dimensions of the high-dimensional data. The permutation of the low-dimensional data may be transformed by being encoded through the tokenization of the entity of the feature embedding vector for each dimension.

Furthermore, step S1030 may include a process of obtaining a set of the high-dimensional data as learning data.

The method proposed in this specification may help in solving the following problems.

### (1) Detection of Distribution Shift

Today a machine learning model including a multi-layer neural network is insufficient in the metacognitive ability to determine the reliability of its own result value. The machine learning model frequently assigns excessive reliability to its output although the output is a wrong answer. Such a characteristic becomes the biggest barrier to the introduction of artificial intelligence in fields, such as medical care and autonomous driving whose safety is important. The field whose safety is important requires a technology in which the machine learning model previously recognizes that a machine may malfunction when the danger of the malfunction is high and handles the danger.

Most cases in which the machine learning model malfunctions are described by a distribution shift in which a distribution of learning data and inference data is changed. In the present disclosure, whether the distribution has been changed may be determined by measuring the likelihood of input data. When the likelihood of input data or a set of the input data is lower than a specific threshold, corresponding data has a good possibility that the corresponding data will be data not learnt in a learning process. Accordingly, the machine learning model may take measures by considering that the malfunction possibility of a machine is high.

### (2) Outlier Detection

The outlier detection that is used in process monitoring, security, and safety control means that a normal state is defined and outlier data are detected. It is difficult to apply supervised learning to outlier detection because an outlier refers to everything that is not normal. This is because the outlier detection requires constructing an abnormal dataset that includes all things that are not normal in the world.

The outlier detection may be performed in a way to determine data having very low likelihood in a learnt distribution of input data as an outlier through the likelihood measurement method proposed in the present disclosure. In the case of the method proposed in the present disclosure, learning is performed in the self-supervised way and performed in a way to measure the likelihood of all data without separate labeling. Accordingly, the labeling of normal data and abnormal data of a learning dataset is not required, and the outlier detection can be naturally achieved.

### (3) Novelty Discovery

The novelty discovery means that when data having a pattern not present in a learning dataset are input, it is recognized that the input data has novelty and a new category is designated by collecting data having similar patterns.

In the present disclosure, the learning of an inference dataset is also possible because learning is performed in the self-supervised way. Accordingly, a distribution of learning datasets is first learnt, and a distribution of inference datasets is separately learnt. Thereafter, the novelty discovery may be performed by collecting data having a low likelihood in the distribution of the learning datasets, but having a high distribution in the inference datasets.

### (4) Active Learning, Curriculum Learning

In the learning of a multi-layer neural network, there is a case in which it is necessary to determine the importance of learning data based on specialty within a dataset. The reason for this is that a labeling cost can be reduced or efficiency of computation resources can be improved through the importance of learning data.

According to the method proposed in the present disclosure, the method may be used in such a task because the likelihood of each datum within a learning dataset can be determined. For example, in the case of active learning, in order to minimize a labeling cost that is involved by a person, a method of selecting only data having a low likelihood on the basis of a distribution of the existing learning datasets and requesting the labeling of the selected data may be used. The method of the present disclosure may be used in the determination of the likelihood. In the case of curriculum learning, in order to improve the stability of optimization, it may be necessary to first learn data similar to a distribution of learning data. In this case, after a likelihood is measured by using the method of the present disclosure, data having a high likelihood may be first learnt.

### (5) Model Selection

If a system including several models that use different datasets is present, there is a case in which it is difficult to determine which model will be used. For example, in the case of an OCR-based translator, there is a case in which it is necessary to analyze to which character a detected character belongs. It may be necessary to analyze which character set a detected character belongs to. In the case of an autonomous vehicle, it may be necessary to determine the weather-time domain to which an image obtained from a camera belongs.

According to an embodiment of the present disclosure, it is possible to confirm and analyze that input data come out from any in-distribution data of a learning dataset, among several learning datasets, by estimating the matching of the input data and the learning dataset at inference timing, which may help in the model selection.

A suitable model may be invoked by checking the possibility that input data would have been derived from a distribution of which datasets, among several learning datasets, is the highest. A method of invoking a model that has learnt corresponding data after assuming that input data belong to a distribution in which the input data have a maximum likelihood according to a maximum likelihood estimation method may be used. In the aforementioned embodiments, the components and characteristics of the present disclosure have been combined in a specific form. Each of the components or characteristics may be considered to be optional unless otherwise described explicitly. Each of the components or characteristics may be implemented in a form to be not combined with other components or characteristics. Furthermore, some of the components or the characteristics may be combined to form an embodiment of the present disclosure. The sequence of the operations described in the embodiments of the present disclosure may be changed. Some of the components or characteristics of an embodiment may be included in another embodiment or may be replaced with corresponding components or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be embodied in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

### DESCRIPTION OF REFERENCE NUMERAL

10: measuring apparatus

What is claimed is:

1. A measuring apparatus for measuring a likelihood of new input data related to a dataset comprising multi-dimensional data through high-dimensional distribution estimation of the dataset, the measuring apparatus comprising:
an input module configured to receive input data;
an AI module configured to transform high-dimensional data into low-dimensional data by using a feature embedding vector and to learn a joint probability of the high-dimensional data by combining a conditional probability corresponding to an associative relation between entities of the low-dimensional data for each dimension and a marginal probability that is generated based on a histogram of the low-dimensional data for each dimension; and
an output module configured to output a likelihood of determining whether the new input data correspond to out-of-distribution data of the dataset based on the learnt joint probability.

2. The measuring apparatus of claim 1, wherein the AI module comprises:
a first multi-layer neural network configured to extract the feature embedding vector of the high-dimensional data;
a tokenizer configured to transform the high-dimensional data into a permutation of the low-dimensional data by using a tokenization of an entity of the feature embedding vector for each dimension;
memory configured to generate the histogram of the transformed low-dimensional data for each dimension and to store the marginal probability of the low-dimensional data;
a second multi-layer neural network configured to learn the conditional probability and the joint probability by using a multi-layer neural network model; and
a probability collection module configured to calculate the joint probability by combining the conditional probability and the marginal probability according to a chain rule.

3. The measuring apparatus of claim 2, wherein the AI module
obtains a set of the high-dimensional data as learning data,
extracts the feature embedding vector comprising some dimensions of the high-dimensional data from the high-dimensional data,
transforms the obtained high-dimensional data into the permutation of the low-dimensional data by performing encoding through the tokenization of the entity of the extracted feature embedding vector for each dimension, and
learns a conditional probability corresponding to an associative relation between the entities of the transformed low-dimensional data for each dimension through the multi-layer neural network model.

4. The measuring apparatus of claim 3, wherein the second multi-layer neural network generates a plurality of encoding intervals for each entity by dividing an interval between a maximum value and minimum value of the entity of the extracted feature embedding vector for each dimension, searches for an encoding interval comprising an entity, among the plurality of encoding interval, sets a value of an entity corresponding to the retrieved encoding interval to “1” and sets a value of an entity corresponding to remaining intervals except the retrieved encoding interval to “0”, and performs encoding through the tokenization of the entity of the extracted feature embedding vector for each dimension.

5. The measuring apparatus of claim 1, wherein the multi-layer neural network model is a transformer using only a decoder.

6. The measuring apparatus of claim 1, wherein the conditional probability is a probability corresponding to a subsequent input value of a stream of previously input data.

7. The measuring apparatus of claim 2, wherein the first multi-layer neural network comprises a feature extraction unit and a main task module.

8. The measuring apparatus of claim 4, wherein the encoded value is accumulated and stored in the memory for each dimension.

9. A method of measuring a likelihood of new input data related to a dataset comprising multi-dimensional data through high-dimensional distribution estimation of the dataset, the method comprising:
receiving new input data;
transforming high-dimensional data into low-dimensional data by using a feature embedding vector;
learning a joint probability of the high-dimensional data by combining a conditional probability corresponding to an associative relation between entities of the low-dimensional data for each dimension and a marginal probability that is generated based on a histogram of the low-dimensional data for each dimension; and
outputting a likelihood of determining whether the new input data correspond to out-of-distribution data of a dataset based on the learnt joint probability.

10. The method of claim 9, wherein the learning of the joint probability of the high-dimensional data comprises:
extracting the feature embedding vector of the high-dimensional data;
transforming the high-dimensional data into a permutation of the low-dimensional data by using a tokenization of an entity of the feature embedding vector for each dimension;
generating the histogram of the transformed low-dimensional data for each dimension and storing the marginal probability of the low-dimensional data;
learning the conditional probability and the joint probability by using a multi-layer neural network model; and
calculating the joint probability by combining the conditional probability and the marginal probability according to a chain rule.

11. The method of claim 10, wherein the learning of the conditional probability and the joint probability by using the multi-layer neural network model further comprises obtaining a set of the high-dimensional data as learning data.

12. The method of claim 11, wherein:
the feature embedding vector comprises some dimensions of the high-dimensional data, and
the permutation of the low-dimensional data is transformed by being encoded through the tokenization of the entity of the feature embedding vector for each dimension.

13. The method of claim 12, wherein the encoding comprises:
generating a plurality of encoding intervals for each entity by dividing an interval between a maximum value and minimum value of the entity of the extracted feature embedding vector for each dimension,
searching for an encoding interval comprising an entity, among the plurality of encoding interval, and
setting a value of an entity corresponding to the retrieved encoding interval to “1” and setting a value of an entity corresponding to remaining intervals except the retrieved encoding interval to “0”.

14. The method of claim 9, wherein the multi-layer neural network model is a transformer using only a decoder.

15. The method of claim 9, wherein the conditional probability is a probability corresponding to a subsequent input value of a stream of previously input data.

16. An AI apparatus for learning a distribution of high-dimensional learning data sets, the AI apparatus comprising:
a data transformation module configured to extract a feature embedding vector of high-dimensional data and to perform a main task by using the extracted feature embedding vector;
memory configured to generate a histogram of low-dimensional data for each dimension and to store a marginal probability of the low-dimensional data;
a data learning module configured to transform the high-dimensional data into the permutation of the low-dimensional data by using a tokenization of an entity of the extracted feature embedding vector for each dimension and to learn a conditional probability and a joint probability by using a multi-layer neural network model; and
a probability collection module configured to calculate the joint probability by combining the conditional probability and the marginal probability according to a chain rule.

17. The AI apparatus of claim 16, further comprising a learning data acquisition module configured to obtain a set of the high-dimensional data as learning data.

18. The AI apparatus of claim 17, wherein the data learning module further comprises a model learning module configured to transform the high-dimensional data into a permutation of the low-dimensional data by performing encoding through the tokenization of the entity of the extracted feature embedding vector for each dimension and to learn a conditional probability corresponding to an associative relation between entities of the transformed low-dimensional data for each dimension by using the multi-layer neural network model.

19. The AI apparatus of claim 18, wherein the data learning module generates a plurality of encoding intervals for each entity by dividing an interval between a maximum value and minimum value of the entity of the extracted feature embedding vector for each dimension, searches for an encoding interval comprising an entity, among the plurality of encoding interval, sets a value of an entity corresponding to the retrieved encoding interval to “1” and sets a value of an entity corresponding to remaining intervals except the retrieved encoding interval to “0”, and performs encoding through the tokenization of the entity of the extracted feature embedding vector for each dimension.

20. The AI apparatus of claim 16, wherein the multi-layer neural network model is a transformer using only a decoder.
